(19) United States
(12) Patent Application Publication
(10) Pub. No.: US 2019/0387108 A1
(43) Pub. Date: Dec. 19, 2019

(54) IMAGE COMMUNICATION APPARATUS AND CONTROL METHOD FOR IMAGE COMMUNICATION APPARATUS

(71) Applicant: SHARP KABUSHIKI KAISHA, Sakai City (JP)

(72) Inventors: NOBUHISA WATANABE, Sakai City (JP); SATOSHI TAKAHASHI, Sakai City (JP); TOMOHIRO YOSHIMURA, Sakai City (JP)

(21) Appl. No.: 16/438,080

(22) Filed: Jun. 11, 2019

(30) Foreign Application Priority Data
Jun. 19, 2018 (JP) 2018-116404

(51) Int. Cl. H04N 1/00; H04L 12/58; G06F 3/14

(52) U.S. Cl. CPC H04N 1/00212; H04L 51/22; G06F 3/14; H04N 1/00408; H04L 51/34; H04N 1/00498; H04N 1/00225

(57) ABSTRACT

An image communication apparatus that performs an e-mail communication includes an e-mail transmission unit that transmits an e-mail to which an image file is attached, an e-mail reception unit, a display unit, a communication management unit that manages communication management information of the e-mail transmitted, an information attachment unit that attaches acknowledgement request information to the e-mail to be transmitted, the acknowledgement request information requesting, for a destination of the e-mail, a response mail that indicates an acknowledgement of the e-mail, and an information updating unit that updates, as the communication management information, header information that includes acknowledgement information according to the response mail. The header information is displayed on the display unit as the communication management information.

### BACKGROUND

### 1. Field

The present disclosure relates to an image communication apparatus and the like, and more particularly, to an image communication apparatus and the like that display header information of an e-mail.

### 2. Description of the Related Art

In the related art, an image communication apparatus such as a multifunction peripheral includes a determination unit that determines, in an Internet fax, success or failure of mail transmission by determining acknowledgement information from header information included in the mail. The image communication apparatus usually determines OK/NG of the mail transmission by the determination unit. In addition, with respect to the mail transmitted, a user is notified that the mail is not received at a destination of the transmission based on the fact that a response mail is not returned within a predetermined time.

As the related art, for example, an image communication apparatus has been proposed, which includes an attachment unit, a management unit, and a determination unit. The attachment unit attaches acknowledgement request information to a transmission e-mail to which an image file is attached. The acknowledgement request information requests, for a destination of the transmission e-mail, a response mail indicating an acknowledgement of the transmission e-mail. The management unit manages communication management information of e-mails. The determination unit determines success or failure of the transmission of the transmission e-mail to which the acknowledgement request information requesting the response mail is attached, based on information that is included in the response mail received by a mail reception unit and that indicates the acknowledgement, in other words, based on information indicating how the transmission e-mail is processed at a mail receiver side which is the destination of the transmission e-mail. The management unit updates information indicating a result of the transmission of the transmission e-mail included in the communication management information, based on the result of determination by the determination unit (see Japanese Unexamined Patent Application Publication No. 2006-203947).

With this configuration, the image communication apparatus on a mail transmitter side notifies the user of the details of the acknowledgement status of the transmitted image, and thus it is possible to easily check whether the image file attached to the e-mail for which the acknowledgement is requested is correctly processed at the mail receiver side.

However, according to the technique proposed in Japanese Unexamined Patent Application Publication No. 2006-203947, for example, attaching acknowledgment request information to header information of the e-mail and determining transmission OK/NG at the mail transmitter side based on the header information is inaccurate and may cause misunderstanding to a user.

The present disclosure has been made in view of the above, and it is desirable to provide an image communication apparatus capable of accurately notifying the user of a delivery status of the e-mail on the destination side in accordance with the acknowledgement status.

### SUMMARY

An image communication apparatus according to an aspect of the present disclosure performs an e-mail communication and includes an e-mail transmission unit that transmits an e-mail to which an image file is attached, an e-mail reception unit that receives an e-mail, a display unit that displays information about an e-mail, a communication management unit that manages communication management information of the e-mail transmitted, an information attachment unit that attaches acknowledgement request information to the e-mail to be transmitted by the e-mail transmission unit, the acknowledgement request information requesting, for a destination of the e-mail, a response mail that indicates an acknowledgement of the e-mail, and an information updating unit that updates, as the communication management information, header information that includes acknowledgement information according to the response mail. The header information is displayed on the display unit as the communication management information.

In addition, a control method according to another aspect of the present disclosure is provided for an image communication apparatus that performs an e-mail communication and that includes an e-mail transmission unit that transmits an e-mail to which an image file is attached, an e-mail reception unit that receives an e-mail, and a display unit that displays information about an e-mail, the control method including: managing communication management information of the e-mail transmitted; attaching acknowledgement request information to the e-mail to be transmitted by the e-mail transmission unit, the acknowledgement request information requesting, for a destination of the e-mail, a response mail that indicates an acknowledgement of the e-mail, and updating, as the communication management information, header information that includes acknowledgement information according to the response mail. The header information is displayed on the display unit as the communication management information.

### BRIEF DESCRIPTION OF THE DRAWINGS

FIG. 1 is a block diagram illustrating a configuration of an image communication apparatus according to a first embodiment;

FIG. 2 is an illustration of a state of communicating an e-mail by the image communication apparatus;

FIG. 3 is an illustration of part of an acknowledgement mail to be notified to the image communication apparatus;

FIG. 4 is an illustration of part of an acknowledgement mail to be notified to an image communication apparatus according to a second embodiment;

FIG. 5A is an illustration of an example of a communication status display screen that displays a communication state when an image communication apparatus according to a third embodiment is waiting for reception of a response mail with respect to an e-mail transmitted by the image communication apparatus;

FIG. 5B is an illustration of an example of a communication status display screen that displays a communication state when timeout has occurred while waiting for reception of the response mail with respect to the e-mail transmitted by the image communication apparatus according to the third embodiment;

FIG. 6 is an illustration of an example of a communication status display screen that displays a communication state of a response mail with respect to an e-mail transmitted by an image communication apparatus according to a fourth embodiment; and

FIG. 7 is an illustration of an example in which a pop image is displayed in addition to the communication status display screen in the image communication apparatus.

### DESCRIPTION OF THE EMBODIMENTS

### First Embodiment

Hereinafter, a first embodiment of the present disclosure will be described with reference to the drawings.

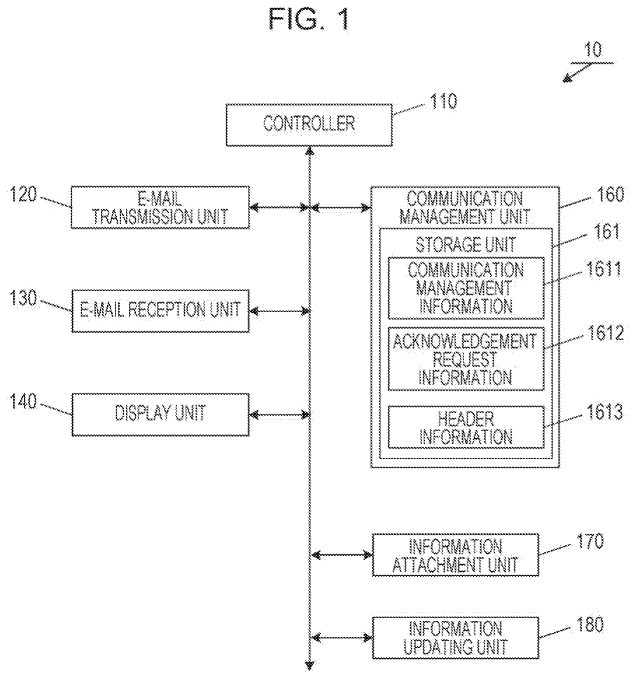

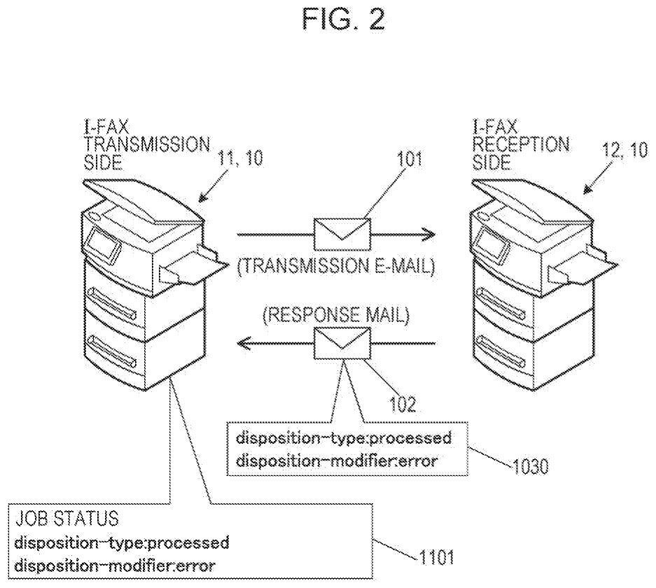

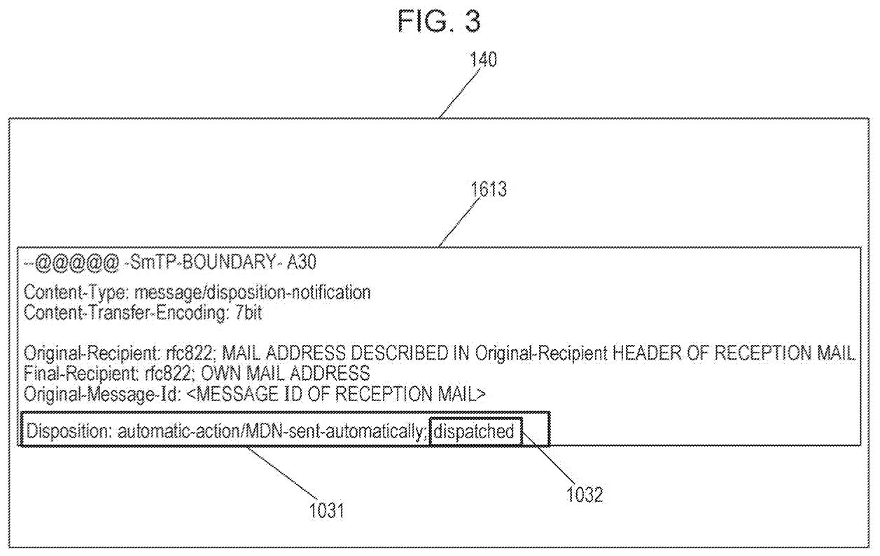

FIG. 1 is an example of an embodiment of the present disclosure, and is a block diagram illustrating a configuration of an image communication apparatus according to a first embodiment of the present disclosure; FIG. 2 is an illustration of a state of communicating an e-mail by the image communication apparatus, and FIG. 3 is an illustration of part of an acknowledgement mail to be notified to the image communication apparatus.

The image communication apparatus 10 according to the first embodiment is, as illustrated in FIG. 1, performs e-mail communication and includes an e-mail transmission unit 120 that transmits an e-mail to which an image file is attached, an e-mail reception unit 130 that receives an e-mail, and a display unit 140 capable of displaying communication result and the like of an e-mail. The image communication apparatus 10 further includes a communication management unit 160 that manages communication management information of the e-mail transmitted (hereinafter referred to as “transmission e-mail”), an information attachment unit 170 that attaches acknowledgement request information to the e-mail to be transmitted by the e-mail transmission unit 120, the acknowledgement request information requesting, for a destination of the e-mail, a response mail (acknowledgement mail) that indicates an acknowledgement of the e-mail, and an information updating unit 180 that updates, as the communication management information, header information that includes acknowledgement information according to the response mail. A controller 110 controls the display unit 140 to display the header information as it is as communication management information.

The communication management unit 160 includes a storage unit 161 which stores communication management information 1611, acknowledgement request information 1612, header information 1613, and the like for the e-mail.

Here, the acknowledgement request information 1612 indicates that the response mail notifying the acknowledgement is requested.

When the mail communication is performed between the image communication apparatuses through the Internet fax, as illustrated in FIG. 2, a transmission e-mail 101 is transmitted from an image communication apparatus 11 (10) on the mail transmission side to an image communication apparatus 12 (10) on the mail reception side. When receiving the transmission e-mail 101, the image communication apparatus 12 on the mail reception side transmits a response mail 102 indicating that the transmission e-mail 101 has been received to the image communication apparatus 11 on the mail transmission side.

The response mail 102 includes acknowledgement information 1030 “disposition-type: processed” and “disposition-modifier: error” as reception status of the image communication apparatus 12 on the mail reception side.

When receiving the response mail 102, the image communication apparatus 11 on the mail transmission side is notified that a job status 1101 of the transmission e-mail 101 is “disposition-type: processed” and “disposition-modifier: error” from the acknowledgement information 1030.

Here, the header information of the response mail 102 will be described by way of examples.

As illustrated in FIG. 3, acknowledgement information 1031 about the transmission e-mail is added to header information 1613 of the response mail 102. In the acknowledgement information 1031, “dispatched” is displayed as transmission e-mail opening information 1032.

In the first embodiment, as described above, the header information 1613 is displayed on the display unit 140 and the acknowledgement information 1031 included in the response mail 102 is displayed as it is, and thus the communication state of the transmission e-mail 101 may be accurately notified to the user.

With this configuration, according to the first embodiment, the image communication apparatus 10 includes an e-mail transmission unit 120, an e-mail reception unit 130, and a display unit 140, further includes a communication management unit 160, an information attachment unit 170, and an information updating unit 180, and the header information 1613 including the acknowledgement information 1031 included in the response mail 102 is displayed as it is on the display unit 140 as the communication management information. Thus, the user may be accurately notified of the delivery status of the transmission e-mail 101 in the image communication apparatus on the destination side (reception side).

### Second Embodiment

Next, a second embodiment will be described with reference to the drawings.

For convenience of explanation, the same reference numerals are given to configurations having the same functions as the first embodiment, and the description thereof will not be repeated.

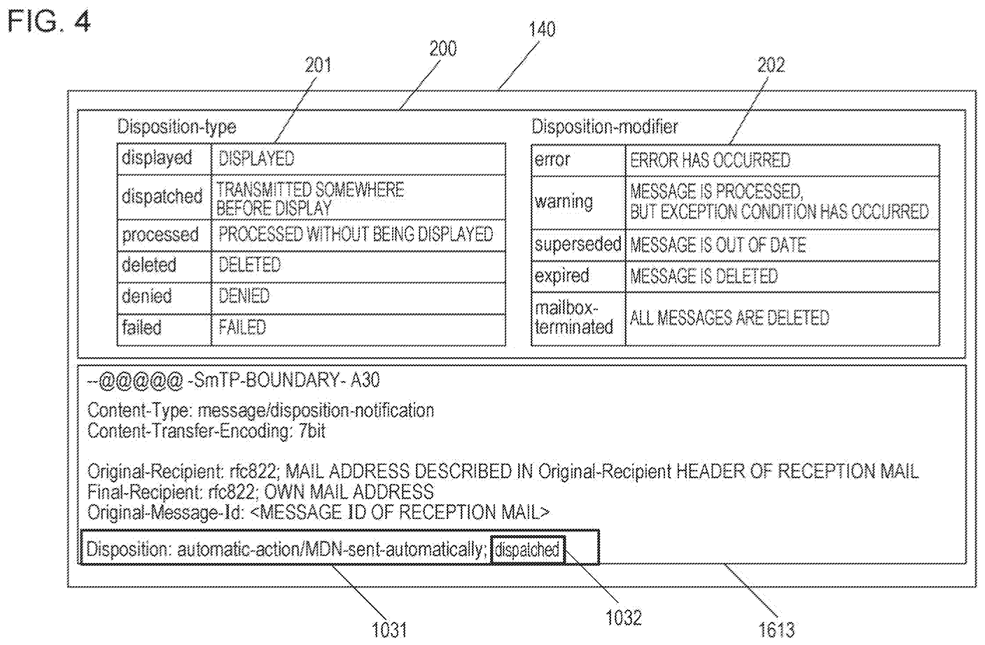

FIG. 4 is an illustration of part of an acknowledgement mail to be notified to the image communication apparatus according to a second embodiment.

In the second embodiment, as illustrated in FIG. 2, when the image communication apparatus 10 performs an e-mail communication through the Internet fax, a response mail 102 with respect to the transmission e-mail 101 is received, and communication management information is displayed on the display unit 140 as header information, a description of a wording is displayed in Japanese notation in order that the user may easily understand.

In the second embodiment, as illustrated in FIG. 4, in addition to the acknowledgement information 1031 of the response mail 102 displayed together with the header information 1613, the Japanese translation description information 200 that describes the wording used in the acknowledgement information 1031 is displayed on the display unit 140.

As the Japanese translation description information 200, first Japanese translation description information 201 corresponding to “Disposition-type” and second Japanese translation description information 202 corresponding to “Disposition-modifier” are displayed.

With respect to information of the wordings “displayed”, “dispatched”, “processed”, “deleted”, “denied”, and “failed” used in “Disposition-type”, the first Japanese translation description information 201 displays Japanese translation description message such as “DISPLAYED”, “TRANSMITTED SOMEWHERE BEFORE DISPLAY”, “PROCESSED WITHOUT BEING DISPLAYED”, “DELETED”, “DENIED”, and “FAILED” representing the meaning of each of the wordings.

With respect to information of the wordings “error”, “warning”, “superseded”, “expired”, and “mailbox-terminated” used in “Disposition-modifier”, the second Japanese translation description information 202 displays Japanese translation description message such as “ERROR HAS OCCURRED”, “MESSAGE IS PROCESSED BUT EXCEPTION STATE HAS OCCURRED”, “MESSAGE IS OUT OF DATE”, “MESSAGE IS DELETED”, and “ALL MESSAGES ARE DELETED” representing the meaning of each of the wordings.

With this configuration, according to the second embodiment, when the header information 1613 is displayed on the display unit 140 in the image communication apparatus 10, in addition to the acknowledgement information 1031, Japanese translation description information 200 that describes the wording in Japanese notation is displayed, and thus the communication state of the transmission e-mail 101 is easily understood by the user.

### Third Embodiment

Next, a third embodiment will be described with reference to the drawings.

For convenience of explanation, the same reference numerals are given to configurations having the same functions as the first embodiment, and the description thereof will not be repeated.

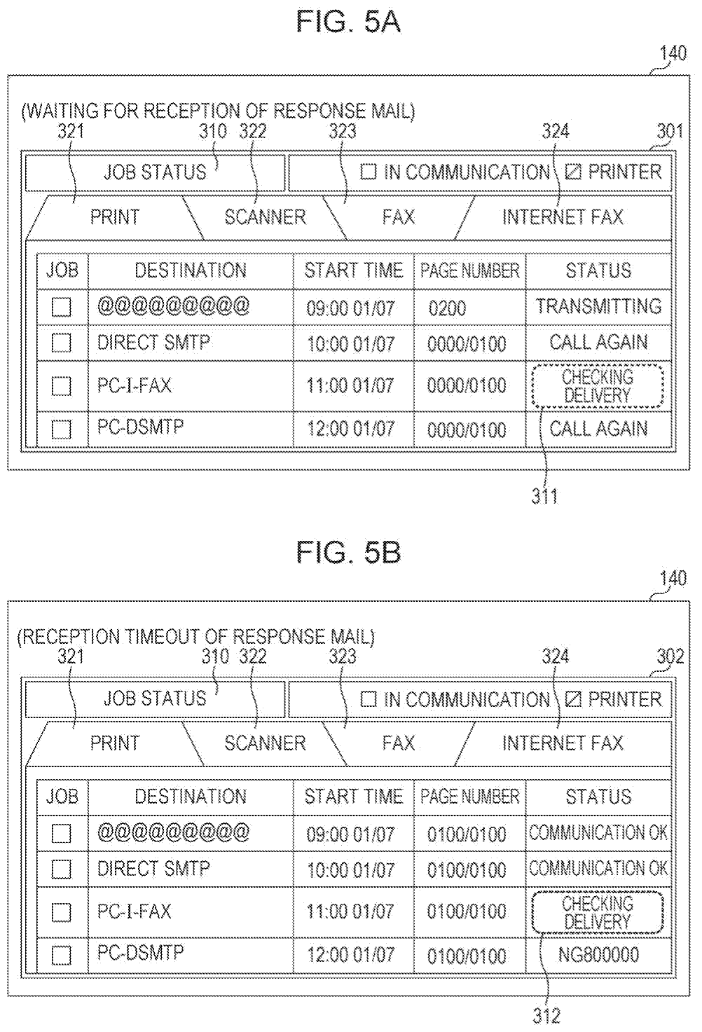

FIG. 5A is an illustration of an example of a communication status display screen that displays a communication state when an image communication apparatus according to the third embodiment is waiting for reception of a response mail with respect to an e-mail transmitted by the image communication apparatus. FIG. 5B is an illustration of an example of a communication status display screen that displays the communication state when timeout has occurred while waiting for reception of the response mail with respect to the e-mail transmitted by the image communication apparatus according to the third embodiment.

According to the third embodiment, in the image communication apparatus 10, when the response mail with respect to the transmitted e-mail is in the communication state, a communication status display screen 301 indicating the communication status of the response mail is displayed on the display unit 140, and the communication state of the response mail is displayed on the communication status display screen 301.

According to the third embodiment, when the image communication apparatus 10 is waiting for reception of the response mail 102, as illustrated in FIG. 5A, a first communication status display screen 301 indicating the status of “waiting for reception of response mail” is displayed on the display unit 140.

A job status 310 is displayed and the communication status of each job for a corresponding destination is displayed on the first communication status display screen 301. In addition, respective functions may be selected by a display print key 321, a scanner key 322, a fax key 323, and an Internet fax key 324.

“checking delivery” is displayed with respect to the job status 311 of the Internet fax when waiting for the reception of the response mail.

Meanwhile, in the image communication apparatus 10, when timeout has occurred while waiting for reception of the response mail 102, as illustrated in FIG. 5B, a second communication status display screen 302 indicating the status of “reception timeout of response mail” is displayed on the display unit 140.

Likewise the first communication status display screen 301, the job status 310 is displayed, and the display print key 321, the scanner key 322, the fax key 323, and the Internet fax key 324 are displayed on the second communication status display screen 302.

“checking delivery” is displayed with respect to the job status 312 of the Internet fax when timeout has occurred while waiting for the reception of the response mail.

In this way, even if timeout has occurred while waiting for reception of the response mail, “checking delivery” is displayed, and therefore, in a case in which there is a time lag in reception of the response mail, the correct status is displayed when the job status is updated next time.

With this configuration, according to the third embodiment, when the response mail with respect to the transmitted e-mail is in the communication state, the image communication apparatus 10 displays the communication status display screen 301 on the display unit 140, and the communication state of the response mail is displayed on the communication status display screen 301, and in a case in which the image communication apparatus 10 has not received the response mail 102 within a predetermined time, reception of the response mail 102 is being checked with respect to the job status of Internet fax, and therefore, in a case in which there is a time lag in reception of the response mail 102, the correct status is displayed when the job status is updated next time, and the user is notified accurately of the delivery status of the transmission e-mail 101.

### Fourth Embodiment

Next, a fourth embodiment will be described with reference to the drawings.

For convenience of explanation, the same reference numerals are given to configurations having the same functions as the first embodiment, and the description thereof will not be repeated.

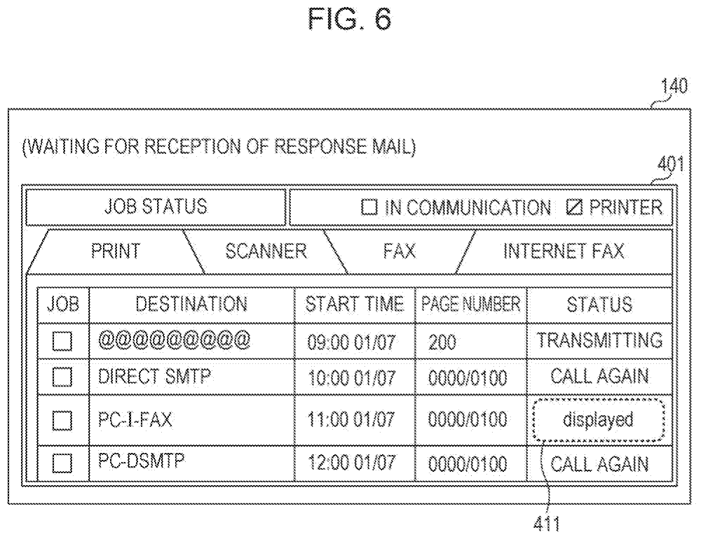

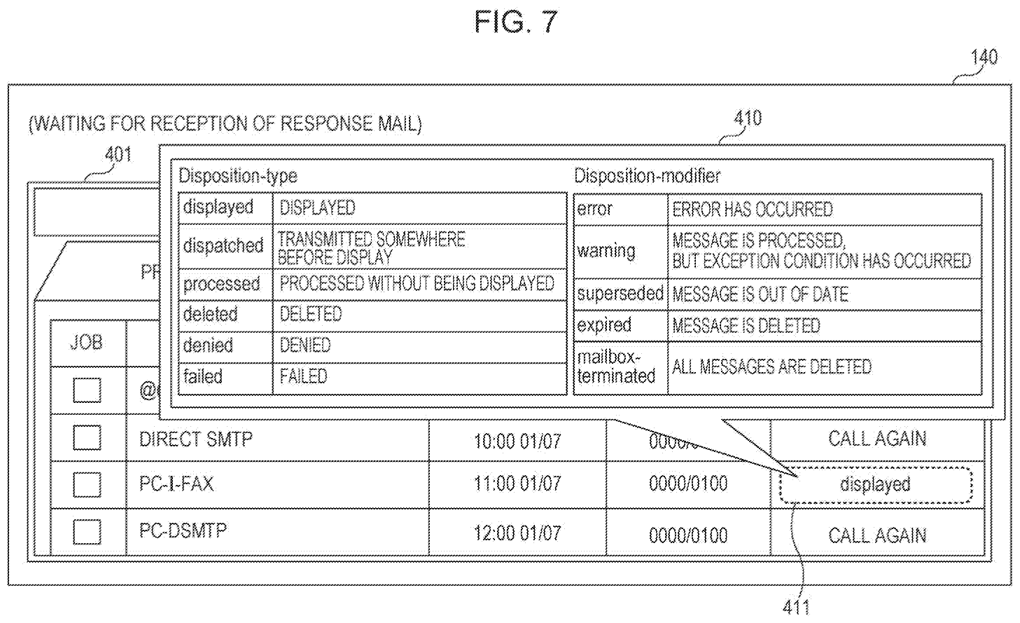

FIG. 6 is an illustration of an example of a communication status display screen that displays a communication state of a response mail with respect to an e-mail transmitted by the image communication apparatus according to the fourth embodiment, and FIG. 7 is an illustration of an example in which a pop image is displayed in addition to the communication status display screen in the image communication apparatus.

In the fourth embodiment, in the image communication apparatus 10, when the response mail with respect to the transmitted e-mail is in the communication state, the display unit 140 displays the communication status display screen 401 indicating the communication status of the response mail, and the header information indicating the communication status is displayed on the communication status display screen 401. In addition, when the header information is selectively operated, the Japanese notation of the header information or a description of a wording is further displayed.

In the fourth embodiment, “displayed” is displayed with respect to header information 411 indicating the job status of the Internet fax when waiting for the reception of the response mail.

When the header information 411 on the communication status display screen 401 is touch-operated, as illustrated in FIG. 7, a pop image 410 including the Japanese notation of the header information 411 is displayed.

With this configuration, according to the fourth embodiment, in the image communication apparatus 10, when the response mail with respect to the transmitted e-mail is in the communication state, the communication status display screen 401 is displayed on the display unit 140, and the header information 411 indicating the communication status is displayed on the communication status display screen 401, and the header information 411 is touched, so that the Japanese notation of the header information is displayed by the pop image 410, as a result, a user may easily check the communication state of the response mail.

Detailed information on the header information according to the embodiments described above may be stored in the image communication apparatus 10, or may be acquired from an external server or information over the Internet.

As described above, the present disclosure is not limited to the embodiments described above, and various modifications may be realized within the scope of the claims. It will be apparent that those skilled in the art can come up with various kinds of alterations or modifications within the scope described in the claims, that is, embodiments obtained by appropriately combining modified technical means without departing from the scope of the present disclosure are also included in the technical scope of the present disclosure.

The present disclosure contains subject matter related to that disclosed in Japanese Priority Patent Application JP 2018-116404 filed in the Japan Patent Office on Jun. 19, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image communication apparatus that performs an e-mail communication, comprising:
an e-mail transmission unit that transmits an e-mail to which an image file is attached;
an e-mail reception unit that receives an e-mail;
a display unit that displays information about an e-mail;
a communication management unit that manages communication management information of the e-mail transmitted;
an information attachment unit that attaches acknowledgement request information to the e-mail to be transmitted by the e-mail transmission unit, the acknowledgement request information requesting, for a destination of the e-mail, a response mail that indicates an acknowledgement of the e-mail; and
an information updating unit that updates, as the communication management information, header information that includes acknowledgement information according to the response mail, wherein
the header information is displayed on the display unit as the communication management information.

2. The image communication apparatus according to claim 1, wherein
the acknowledgement request information is information requesting “Message Disposition Notification”.

3. The image communication apparatus according to claim 1, wherein
the header information is notified by adding at least one of a Japanese notation or a description of a wording.

4. The image communication apparatus according to claim 3, wherein
a communication status display screen indicating a communication status of the response mail is displayed on the display unit, and
when the image communication apparatus is waiting for reception of the response mail, a state that a delivery of the response mail is being checked is displayed on the communication status display screen.

5. The image communication apparatus according to claim 4, wherein
when the response mail is not received within a predetermined time, the state that the delivery of the response mail is being checked is displayed on the communication status display screen.

6. The image communication apparatus according to claim 3, wherein
a communication status display screen indicating a communication status of the response mail is displayed on the display unit,
header information indicating the communication status is displayed on the communication status display screen, and
when the header information is selectively operated, the Japanese notation or the description of the wording of the header information is further displayed.

7. A control method for an image communication apparatus that performs an e-mail communication and that includes an e-mail transmission unit that transmits an e-mail to which an image file is attached, an e-mail reception unit that receives an e-mail, and a display unit that displays information about an e-mail,
the control method comprising:
managing communication management information of the e-mail transmitted;
attaching acknowledgement request information to the e-mail to be transmitted by the e-mail transmission unit, the acknowledgement request information requesting, for a destination of the e-mail, a response mail that indicates an acknowledgement of the e-mail; and
updating, as the communication management information, header information that includes acknowledgement information according to the response mail, wherein
the header information is displayed on the display unit as the communication management information.
